(19) United States
(12) Patent Application Publication
(10) Pub. No.: US 2008/0011047 A1
(43) Pub. Date: Jan. 17, 2008

(54) VEHICLE SIMULATED CRASH TEST APPARATUS

(75) Inventor: Christopher E. Dragan, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/457,875

(22) Filed: Jul. 17, 2006

(51) Int. Cl. G01N 3/30

(52) U.S. Cl. 73/12.07

(57) ABSTRACT

A vehicle crash test apparatus for conducting simulated automotive crash tests. The apparatus includes a pair of rails and a vehicle buck. A vehicle suspension system having characteristics analogous to an actual vehicle suspension system supports the buck above the rails. An actuator accelerates the rails with the attached vehicle buck at an acceleration rate corresponding to an actual vehicle crash.

### BACKGROUND OF THE INVENTION

I. Field of the Invention

The present invention relates to a simulated crash test apparatus for automotive vehicles.

II. Description of Related Art

Automotive companies necessarily conduct crash tests on automotive vehicles not only to meet government crash test standards, but also for engineering study, design and quality control purposes. Typically, a plurality of crash tests are conducted on a particular vehicle model prior to release of that vehicle model for manufacture.

Due to the high cost of automotive vehicles, however, it is the conventional practice in the automotive industry to conduct simulated crash tests, commonly referred to as “sled tests,” on partial vehicles, commonly referred to as “vehicle bucks”. Such vehicle bucks are significantly less expensive to construct than the complete vehicle, and can be reused for a plurality of sled tests.

During a typical sled test, the vehicle buck is rigidly mounted to a base. The base is free to translate along a set of parallel rails while moving means, such as a hydraulic piston and cylinder, move the buck relative to the rails so that the acceleration of the buck mimics, as closely as possible, the negative of deceleration of an actual vehicle, in an actual frontal crash test.

One disadvantage of this previously known simulated crash test apparatus, however, is that, due to the rigid mounting of the vehicle buck to the base, the vehicle buck is unable to pitch, yaw, roll, and otherwise move in response to acceleration of the buck in the same fashion as an actual impact with a vehicle. Consequently, the test results utilizing these previously known crash test apparatuses inherently suffer from inaccuracies in the overall test crash results.

### SUMMARY OF THE PRESENT INVENTION

The present invention provides a vehicle simulated crash test apparatus which overcomes the above-mentioned disadvantages of the previously known devices.

In brief, the vehicle test crash apparatus comprises a base and a vehicle buck. Unlike the previously known crash test apparatuses, however, the vehicle buck is mounted to and supported above the base by a vehicle suspension system which simulates the suspension system of the automotive vehicle corresponding to the vehicle buck.

Preferably, the suspension system includes at least one and preferably several springs. Similarly, the suspension system also includes one or more shock absorbers or dashpots of the type commonly found an automotive vehicles.

The vehicle buck is positioned on a set of parallel rails, with freedom to translate in the vehicle buck longitudinal axis. Means are then provided for moving the buck relative to the rails such that the buck accelerates “rearward”.

Since the suspension system between the base and the vehicle buck simulates the suspension system of an actual automotive vehicle corresponding to the buck, the vehicle buck may pitch, yaw, and roll, as well as move in a complex combination of motions during the impact. Unlike the previously known apparatuses, since the suspension system simulates the suspension system of the actual automotive vehicle, the test results from the crash test more closely approximate the response of an actual automotive vehicle during a similar crash.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a side view illustrating a preferred embodiment of the vehicle crash test apparatus of the present invention prior to impact;

FIG. 2 is a view similar to FIG. 1, but illustrating the crash simulation test apparatus at impact during the crash simulation test; and

FIG. 3 is a diagrammatic top plan view of the crash test apparatus.

### DETAILED DESCRIPTION OF A PREFERRED EMBODIMENT OF THE PRESENT INVENTION

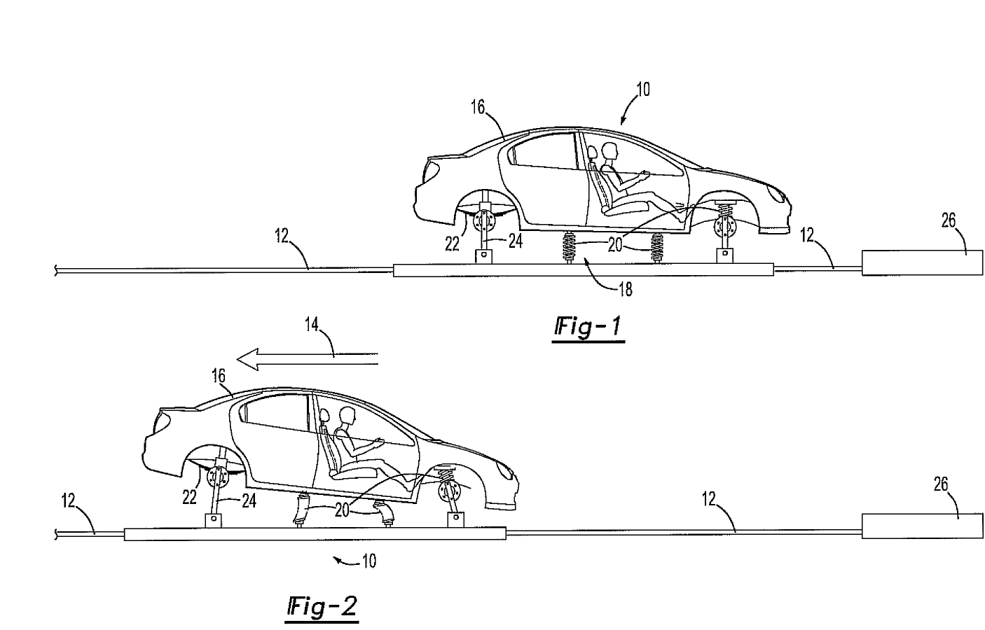

With reference first to FIG. 1, a preferred embodiment of a vehicle crash test apparatus 10 according to the present invention is shown. The test crash apparatus 10 includes a pair of rails 12 that are fixed to ground.

A partial vehicle or vehicle buck 16 is mounted above the rails 12 by a suspension system 18. Furthermore, although in the preferred embodiment of the invention, the vehicle buck 16 is merely a partial vehicle, it will also be understood that, as used herein, the term “vehicle buck” shall include not only a partial vehicle, but also a whole vehicle.

Still referring to FIG. 1, the suspension system 18 simulates the actual suspension system of the automotive vehicle which corresponds to the vehicle buck 16. As such, the suspension system 18 preferably includes one or more compression springs 20. The suspension system may also include one or more leaf spring assemblies 22 of the type commonly found on automotive vehicles. Consequently, the suspension system 18 flexibly or non-rigidly supports the vehicle buck 16 above the rails 12.

The suspension system 18 also preferably includes one or more shock absorbers 24 of the type found on automotive vehicles. The shock absorbers may take any form including, for example, dashpot shock absorbers, struts, and any other type of shock absorber used on automotive vehicles.

It will be understood, of course, that the actual suspension system 18 will vary from one vehicle buck 16 to another. For example, the actual springs and/or shock absorbers constituting the suspension system 18 for a pickup truck would typically be different than a suspension system 18 for a sports car.

Still referring to FIG. 1, a moving means 26, illustrated only diagrammatically, is operatively connected to the rails 12. This moving means 26 is operable to move the attached buck 16 in a rearward direction 14 along the rails 12. The moving means 26 may be of any conventional construction such as a hydraulic piston and cylinder arrangement, gearing arrangements, electric motors, internal combustion motor, and/or the like. Furthermore, during the crash simulation test, the moving means 26 accelerate the attached vehicle buck 16 along the rails 12 in the rearward direction 14 at a rate corresponding to the deceleration of the vehicle typically measured during an actual crash test.

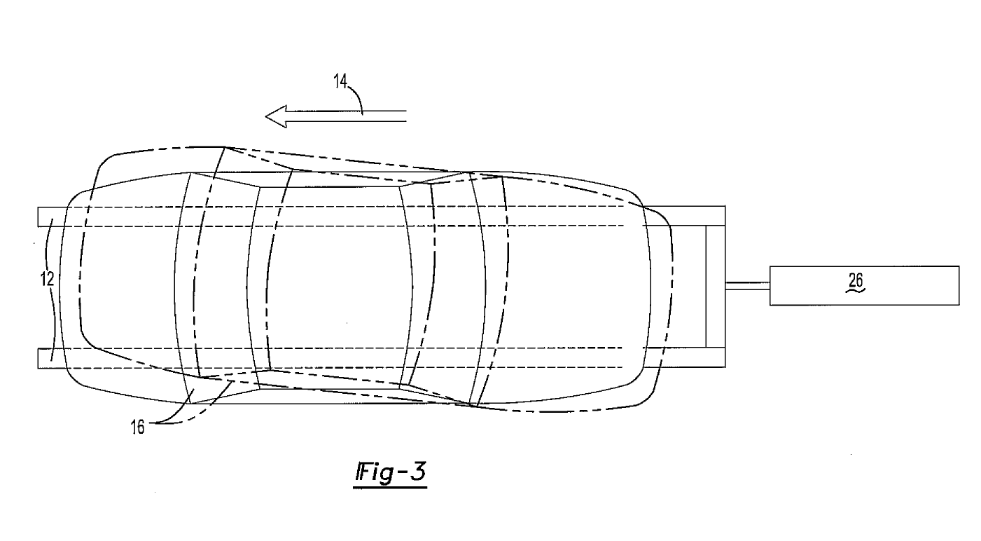

With reference now to FIG. 2, during a crash simulation test, the suspension system 18 allows the vehicle buck 16 to pitch, roll and otherwise move in a fashion which more closely approximates the movement of an actual automotive vehicle during an actual crash. Similarly, as shown in FIG. 3, the suspension system 18 allows the vehicle buck 16 to even rotate in response to the crash simulation.

From the foregoing, it can be seen that the vehicle crash test apparatus of the present invention provides more accurate crash test data than the previously known crash test devices. Having described my invention, however, many modifications thereto will become apparent to those sidled in the art to which it pertains without deviation from the spirit of the invention as defined by the scope of the appended claims.

I claim:

1. A vehicle crash test apparatus comprising:
a vehicle buck,
at least one rail or other means of guiding said vehicle buck,
a vehicle suspension system which supports said vehicle buck above said at least one rail,
means for translating said attached vehicle buck in a direction and at an acceleration rate corresponding to a vehicle crash.

2. The invention as defined in claim 1 wherein said at least one rail comprises a pair of spaced apart rails.

3. The invention as defined in claim 1 wherein said suspension system comprises at least one spring.

4. The invention as defined in claim 3 wherein said suspension system comprises a plurality of springs.

5. The invention as defined in claim 4 wherein at least one of said springs comprises a compression spring.

6. The invention as defined in claim 1 wherein said suspension system comprises at least one shock absorber.

7. The invention as defined in claim 6 wherein said suspension system comprises a plurality of shock absorbers.

8. The invention as defined in claim 9 wherein at least one of said shock absorbers comprises a dashpot shock absorber.

9. The invention as defined in claim 1, wherein said vehicle suspension system provides for movement of said vehicle buck in the x, y, and z directions with respect to said at least one rail.

10. A vehicle crash test apparatus comprising:
a vehicle buck,
at least one rail or other means of guiding said vehicle buck, means for non-rigidly suspending said vehicle buck above said at least one rail; and
means for translating said attached vehicle buck in a direction and at an acceleration rate corresponding to a vehicle crash.

11. The invention as defined in claim 10 wherein said at least one rail comprises a pair of spaced apart rails.

12. The invention as defined in claim 10 wherein said means for non-rigidly suspending comprises at least one spring.

13. The invention as defined in claim 12 wherein said means for non-rigidly suspending comprises a plurality of springs.

14. The invention as defined in claim 13 wherein at least one of said springs comprises a compression spring.

15. The invention as defined in claim 10 wherein said means for non-rigidly suspending comprises at least one shock absorber.

16. The invention as defined in claim 15 wherein said means for non-rigidly suspending comprises a plurality of shock absorbers.

17. The invention as defined in claim 16 wherein at least one of said shock absorbers comprises a dashpot shock absorber.

18. The invention as defined in claim 10 wherein the entirety of said vehicle buck is suspended above said at least one rail by said means for non-rigidly suspending.

19. The invention as defined in claim 10 wherein said means for non-rigidly suspending provides for movement of said vehicle buck in the x, y, and z directions with respect to said at least one rail.
